(19) United States
(12) Patent Application Publication
(10) Pub. No.: US 2021/0178791 A1
(43) Pub. Date: Jun. 17, 2021

(54) THERMAL TRANSFER RIBBON

(71) Applicant: TOPPAN PRINTING CO., LTD., Tokyo (JP)

(72) Inventor: Akira MOTOHASHI, Tokyo (JP)

(73) Assignee: TOPPAN PRINTING CO., LTD., Tokyo (JP)

(21) Appl. No.: 17/186,885

(22) Filed: Feb. 26, 2021

Related U.S. Application Data
(63) Continuation of application No. PCT/JP2019/033611, filed on Aug. 28, 2019.

(30) Foreign Application Priority Data
Aug. 31, 2018 (JP) 2018-163607

(51) Int. Cl. B41J 31/08

(52) U.S. Cl. CPC B41J 31/08

(57) ABSTRACT

A thermal transfer ribbon including a substrate, the substrate has a surface provided with dye layer parts and transferable protective layer parts repeatedly formed thereon, and the transferrable protective layer parts include first layer parts formed on the substrate, and second layer parts formed on the respective first layer parts. The first layer parts contain a charge control agent, and the second layer parts contain an antistatic agent and a lubricant.

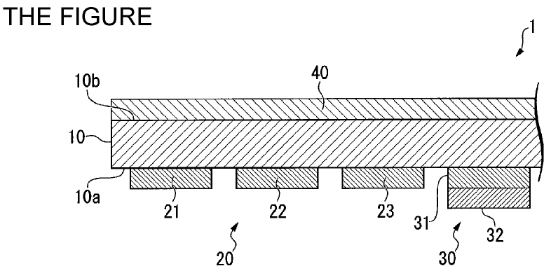

### CROSS-REFERENCE TO RELATED PATENT APPLICATIONS

This application is a continuation application filed under 35 U.S.C. § 111(a) claiming the benefit under 35 U.S.C. §§ 120 and 365(c) of International Patent Application No. PCT/JP2019/033611, filed on Aug. 28, 2019, which is based upon and claims the benefit of priority to Japanese Patent Application No. 2018-163607, filed on Aug. 31, 2018, the disclosures of which are incorporated herein by reference in their entireties.

### BACKGROUND

### Technical Field

Thermal transfer ribbons are ink ribbons used for thermal transfer printers and are also referred to as thermal ribbons. Generally used thermal transfer ribbons have a configuration including a substrate whose first surface is provided with a thermally transferable ink layer and whose second surface is provided with a heat resistant lubricating layer (back coat layer). The ink in the thermally transferable ink layer is sublimated (sublimation transfer method) or melted (melt transfer method) by heat generated by the thermal head of a printer, and transferred to a thermal transfer image-receiving sheet.

Thermal transfer ribbons used for sublimation transfer type printers include a substrate whose first surface is provided with a heat resistant resin layer (back coat layer) and whose second surface is provided with a sublimation dye layer. The sublimation dye layer is an ink layer. Heat applied from the thermal head of such a printer causes dyes in the sublimation layer to sublime and be transferred to an image-receiving layer of an image-receiving sheet.

The sublimation transfer method, coupled with high functionality of printers, facilitates production of various types of images, and thus is currently widely used for cards, such as ID cards, amusement output, and the like.

As such applications are diversified, there is an increasing need for the prints obtained to be protected. In a method prevailing recently, a thermally transferable protective layer is transferred to a transferred image or the like to further improve the protection of the print.

Since higher speed printers have been developed, prints can be continuously produced and ejected in a shorter time. In such high-speed printing, prints adjacent at the top and bottom are required to be ejected in an orderly manner, without being stuck to each other or misaligned, i.e., prints are required to have good handleability.

In this regard, PTL 1 proposes a thermally transferable protective layer imparted with an antistatic function by permitting it to contain a surfactant comprising a quaternary ammonium salt, or an electrically conductive metal oxide, such as zinc antimonate.

PTL 2 proposes an electrically conductive protective layer imparted with an antistatic function by permitting it to contain an electrically conductive inorganic material of needle-shaped crystals.

PTL 3 proposes a thermally transferable protective layer imparted with an antistatic function by permitting it to contain polyethylene dioxythiophene, which is an electrically conductive polymer.

PTL 4 proposes a thermally transferable protective layer imparted with an antistatic function by permitting it to contain a charge control agent.

### CITATION LIST

### Patent Literatures

PTL 1: JP H11-105437 A; PTL 2: JP 2003-145946 A; PTL 3: JP 2011-194707 A; PTL 4: JP 2017-189911 A.

### SUMMARY OF THE INVENTION

### Technical Problem

To impart a sufficient antistatic function to a protective layer using the methods described in PTLs 1 to 4, a relatively large amount of predetermined materials is required to be contained in the protective layer. This unavoidably raises an issue of increasing cost and impairing transparency of the thermally transferable protective layer.

Furthermore, although the details will be described later, it has been found that a protective layer containing a relatively large amount of predetermined materials increases the probability of causing printing wrinkles.

In light of the circumstances set forth above, the present invention aims to provide a thermal transfer ribbon that achieves prints having good handleability with reduced printing wrinkles.

### Solution to Problem

The present invention provides a thermal transfer ribbon which includes a substrate having a surface provided with dye layer parts and transferable protective layer parts repeatedly formed thereon.

The transferrable protective layer parts include first layer parts formed on the substrate, and second layer parts formed on the respective first layer parts. The first layer parts contain a charge control agent, and the second layer parts contain an antistatic agent and a lubricant.

### Advantageous Effects of the Invention

The thermal transfer ribbon of the present invention can achieve prints having good handleability with reduced printing wrinkles.

### BRIEF DESCRIPTION OF THE DRAWINGS

The FIGURE is a schematic cross-sectional view illustrating a thermal transfer ribbon according to an embodiment of the present invention.

### DETAILED DESCRIPTION

Embodiments of the present invention of will be described below with reference to the drawings. In the following description of the drawings to be referred, components or functions identical with or similar to each other are given the same or similar reference signs, unless there is a reason not to. It should be noted that the drawings are only schematically illustrated, and thus the relationship between thickness and two-dimensional size of the components, and the thickness ratio between the layers, are not to scale. Therefore, specific thicknesses and dimensions should be understood in view of the following description. As a matter of course, dimensional relationships or ratios may be different between the drawings.

Further, the embodiments described below are merely examples of configurations for embodying the technical idea of the present invention. The technical idea of the present invention does not limit the materials, shapes, structures, arrangements, and the like of the components to those described below. The technical idea of the present invention can be modified variously within the technical scope defined by the claims. The present invention is not limited to the following embodiments within the scope not departing from the spirit of the present invention.

In any group of successive numerical value ranges described in the present specification, the upper limit value or lower limit value of one numerical value range may be replaced with the upper limit value or lower limit value of another numerical value range. In the numerical value ranges described in the present specification, the upper limit values or lower limit values of the numerical value ranges may be replaced with values shown in examples. The configuration according to a certain embodiment may be applied to other embodiments.

Referring to the FIGURE, an embodiment of the present invention will be described.

The FIGURE is a schematic cross-sectional view illustrating a thermal transfer ribbon 1 according to the present embodiment. As shown in the FIGURE, the thermal transfer ribbon 1 includes a substrate 10, a dye layer 20, a transferrable protective layer 30, and a heat resistant lubricating layer 40. The substrate 10 has a first surface 10a on which the dye layer 20 and the transferrable protective layer 30 are provided. The substrate 10 has a second surface 10b facing away from the first surface 10a, on which the heat resistant lubricating layer 40 is provided. Combinations of parts of dye layer 20 and parts of transferrable protective layer 30 are repeatedly formed in the longitudinal direction of the thermal transfer ribbon 1.

As the substrate 10, various plastic films can be used. From the perspective of achieving high mechanical strength and smooth surfaces, materials for the plastic films may preferably include, but are not particularly limited to, polyester, polyethylene naphthalate, polystyrene, polysulphone, polyimide, polycarbonate, polypropylene, and the like. Of these materials, polyethylene terephthalate (PET) is preferred because it is relatively inexpensive and has high strength, and can form thin films.

As an example, the substrate 10 may have a thickness in the range of about 1 μm to 50 μm, although the thickness is not particularly limited to this.

The dye layer 20 of the present embodiment includes three types of colored layer parts which are yellow dye layer parts 21, magenta dye layer parts 22, and cyan dye layer parts 23. The number and the order of arranging the colored layer parts are not limited to those shown in the mode of the present embodiment, but may be appropriately determined.

The base resin used for the dye layer 20 is preferred to be polyvinyl butyral resin which has a good balance between heat resistance, robustness, dyeability for dyes, and the like.

The polyvinyl butyral resin may have a crosslinked structure. For example, a urethane crosslinked structure can be formed by having polyvinyl butyral resin contained polyol components (hydroxyl groups), and adding an isocyanate crosslinking agent for reaction therewith.

The isocyanate crosslinking agent may comprise a compound having at least one or more isocyanate groups per molecule. For example, a tolylene diisocyanate (TDI) compound, hexamethylene diisocyanate (HDI) compound, methylene diphenyl diisocyanate (MDI) compound, xylylene diisocyanate (XDI) compound, and the like may be mentioned.

Dyes used for the dye layer 20 may be sublimation dyes typically used for thermal transfer ribbons. For example, sublimation dyes may be diarylmethane dyes, triarylmethane dyes, thiazole dyes, methine dyes, azomethine dyes, xanthene dyes, axazine dyes, thiazine dyes, azine dyes, acridine dyes, azo dyes, spirodipiran dyes, indolinospiropyran dyes, fluoran dyes, rhodamine lactam dyes, and anthraquinone dyes, and other dyes.

More specifically, yellow dyes for the yellow dye layer parts 21 may be C.I. Solvent Yellow 14, 16, 29, 30, 33, 56, 93 and the like, and C.I. Disperse Yellow 7, 33, 60, 141, 201, 231 and the like.

Magenta dyes for the magenta dye layer parts 22 may be C.I. Solvent Red 18, 19, 27, 143, 182 and the like, C.I. Disperse Red 60, 73, 135, 167 and the like, and C.I. Disperse Violet 13, 26, 31, 56 and the like. Cyan dyes for the cyan dye layer parts 23 may be C.I. Solvent Blue 11, 36, 63, 105 and the like, and C.I. Disperse Blue 24, 72, 154, 354 and the like.

The layer parts of the dye layer 20 may contain a silicone release agent. The silicone release agent may be amino-modified silicone oil, epoxy-modified silicone oil, and the like.

The method of forming the dye layer 20 is not particularly limited. As an example, the components mentioned above may be added first to a solvent to prepare a dye layer forming ink. The dye layer forming ink may be applied to the substrate 10 by gravure coating or the like, followed by drying, thereby forming a dye layer 20 on the substrate 10.

The solvent may be methyl ethyl ketone, toluene, cyclohexanone, butyl cellosolve, and the like.

There is no particular limitation to the thickness of the layer parts of the dye layer 20. As an example, the layer parts may have a thickness in the range of about 0.5 μm to 2.0 μm, which may be appropriately determined considering the appearance and the like of prints.

The transferrable protective layer 30 is a substantially transparent resin layer and includes first layer parts 31 provided on the substrate 10, and second layer parts 32 formed on the respective first layer parts.

The first layer parts 31 contain a charge control agent. Either of a charge control agent for positive-charging and a charge control agent for negative-charging may be used. The charge control agent for positive charge may be an azine compound, styrene acrylic polymer, azo-containing metal compound, and the like. The charge control agent for negative charge may be an azo-containing metal compound, salicylic acid compound, styrene acrylic polymer, and the like. Of these materials, a styrene acrylic polymer is preferred because of being effective for both positive charge and negative charge. Several charge control agents may be mixed and used.

The content of the charge control agent may preferably be in the range of 0.1% to 5.0%, and more preferably 0.5% to 1%. If the content is 0.1% or less, sufficient effects cannot be obtained. Although the details will be described later, if the content is 5% or more, handleability of prints may be impaired.

As a base resin for the first layer parts 31, an acrylic resin may be used. Examples of the acrylic resin include Dianal (trademark) series BR-88, BR-85, BR-84, BR-82, BR-50, BR-52, BR-90, BR-113, BR-116, and the like manufactured by Mitsubishi Chemical Corporation.

The first layer parts 31 may contain various additives as long as the functions of the layer parts are not impaired. The additives may be an ultraviolet absorbent, photostabilizer, antioxidant, fluorescent whitener, filler, and the like.

The first layer parts 31 may have an appropriately determined thickness, which may, for example, be in the range of about 0.3 μm to 3 μm.

The second layer parts 32 are in contact with or bonded to an image-receiving sheet, and printed layer parts formed on the image-receiving sheet. The second layer parts 32 contain an antistatic agent and a lubricant.

Examples of the antistatic agent may include cationic or anionic surfactants, metallic electrically conductive polymers, metal oxides, compounds comprising hydroxyl groups, and the like. Of these materials, a quaternary ammonium salt is preferred, e.g., CATIOGEN ES-L9 manufactured by DKS Co. Ltd.

The content of the antistatic agent may preferably be in the range of 0.1% to 10%, and more preferably 0.5% to 2.0%. If the content is 0.1% or less, sufficient effects cannot be obtained. If the content is 10% or more, there is a risk of causing printing wrinkles.

Examples of the lubricant include natural wax, synthetic hydrocarbon wax, synthetic ketone wax, chlorinated hydrocarbon wax, higher fatty acid esters, higher fatty acid metal salts, phosphate esters, silicone resins, and the like. Of these materials, a siloxane-modified product is preferred, which may preferably comprise either of an amino-modified silicone and epoxy-modified silicone. The amino-modified silicone may, for example, be amino-modified silicone oil, such as diamino-modified silicone KF393 manufactured by Shin-Etsu Chemical Co., Ltd., or EFKA SL 3031 manufactured by BASF.

The content of the lubricant may preferably be in the range of 0.1% to 2.0%, and more preferably 0.5% to 2.0%. If the content is 0.1% or less, sufficient effect cannot be obtained. If the content is 2.0% or more, foams may be formed from the perspective of miscibility between the modified silicone oil, and resin or solvent, and may impair appearance.

As a base resin for the second layer parts 32, a resin that melts with heat may be used. Examples of such a resin may include styrene resins, such as polystyrene, and poly α-methylstyrene; acrylic resins, such as polymethylmethacrylate, and polyacrylic ethyl; vinyl resins, such as polyvinyl chloride, polyvinyl acetate, vinyl chloride-vinyl acetate copolymer, polyvinyl butyral, and polyvinyl acetal; synthetic resins, such as polyester resin, polyamide resin, epoxy resin, polyurethane resin, petroleum resin, ionomer, ethylene-acrylic acid copolymer, and ethylene-acrylic ester copolymer; cellulose derivatives, such as cellulose nitrate, ethyl cellulose, and cellulose acetate propionate; natural resins and derivatives of synthetic rubber, such as rosin, rosin-modified maleic resin, ester gum, polyisobutylene rubber, butyl rubber, styrene-butadiene rubber, butadiene-acrylonitrile rubber, and polychlorinated olefin; and waxes, such as, carnauba wax, and paraffin wax.

The second layer parts 32 may contain various functional additives, such as an ultraviolet absorbent, photostabilizer, antioxidant, catalyst accelerator, colorant, gloss adjuster, and fluorescent whitener.

The second layer parts 32 may have an appropriately determined thickness which may, for example, be in the range of about 0.5 μm to 3.0 μm.

The heat resistant lubricating layer 40 prevents adhesion between the thermal head of a printer and the thermal transfer ribbon 1 due to heat generated therebetween. The heat resistant lubricating layer 40 contains a binder, lubricant, abrasive, and the like.

The binder may, for example, be a reaction product of a thermoplastic resin comprising hydroxyl groups and an isocyanate. The thermoplastic resin comprising hydroxyl groups may be polyvinyl butyral, polyvinyl acetal, polyester polyol, acrylic polyol, polyether polyol, urethane polyol, and the like. Of these materials, acrylic polyols may be preferable, among which high-molecular weight acrylic polyols are particularly preferred. As the isocyanate, multivalent isocyanates may be used.

As the lubricant, phosphate ester may be used, for example. The phosphate ester may have a structure, for example, in which one or two phosphate groups are esterified per phosphate molecule among three phosphate groups in the molecule. The phosphate ester may preferably be a monoester or a diester of an alkylene oxide adduct of saturated alcohol (e.g., stearyl alcohol, or lauryl alcohol) or unsaturated alcohol (e.g., oleyl alcohol) and a phosphoric acid. The alkylene oxide is preferred to be ethylene oxide, and ethylene oxide units may preferably be in the range of 1 to 20, and more preferably 1 to 8.

The abrasive removes printing debris generated from the heat resistant lubricating layer 40 contacting the thermal head of the printer, or from other layers of the thermal transfer ribbon 1. The abrasive may be magnesium oxide, for example. The magnesium oxide may be one produced through known methods. The known methods include a method in which a carbonate, nitrate, hydroxide, or the like of magnesium is baked and hydrolyzed, a method in which magnesium is subjected to gas-phase oxidation, and other methods.

Other than oxide magnesium, materials used for the abrasive can be oxides such as silica, clay minerals such as talc and kaolin, carbonates such as calcium carbonate and magnesium carbonate, hydroxides such as aluminum hydroxide and magnesium hydroxide, sulfates such as calcium sulfate, inorganic microparticles such as of graphite, saltpeter and boron nitride, organic resin microparticles such as of an acrylic resin, fluororesin, silicone resin, phenol resin, acetal resin, polystyrene resin, nylon resin, and cross-linked resins obtained by reacting these organic resin microparticles with a cross-linking agent, and other materials.

Methods of forming the heat resistant lubricating layer 40 are not particularly limited. As an example, a mixture containing the components mentioned above may be prepared, and the mixture may be applied to one surface of the substrate 10, followed by drying.

The thickness of the heat resistant lubricating layer 40 is not particularly limited, but may, for example, be in the range of 1.0 μm to 1.5 μm.

Operation when using the thermal transfer ribbon 1 configured as described above will be explained.

The thermal transfer ribbon 1 is loaded on a predetermined thermal transfer printer. In the thermal transfer printer, the thermal transfer ribbon 1 is arranged so that the dye layer 20 faces image-receiving sheets. In this state, the thermal transfer ribbon 1 is heated by the thermal head from the heat resistant lubricating layer 40 side, by which the dye layer parts of the dye layer 20 are sublimated and transferred to an image-receiving sheet. In the present embodiment, the yellow dye layer parts 21, the magenta dye layer parts 22, and the cyan dye layer parts 23 are sequentially sublimated and transferred onto the same region of the image-receiving sheet according to the color pattern of the print, and multicolor printed layer parts are finally formed on the image-receiving sheet.

Subsequently, the transferrable protective layer 30 is heated and transferred to the image-receiving sheet to cover the printed layer parts. After completion of all transfer, the printed image-receiving sheet (print) is ejected to a tray of the printer.

Handleability of prints greatly affects how well the prints ejected to the tray are aligned.

One of the factors of determining handleability is the electrical potential on the surface of the image-receiving sheet after thermal transfer. Since the thermal transfer ribbon of the present embodiment contains a charge control agent in the first layer parts 31 of the transferrable protective layer, the potential on the surface of an image-receiving sheet after thermal transfer can be stabilized so that the surface can be electrically charged.

The charge control agent can control electrical charge borne by the surfaces of prints during heat transfer and is expected to impart good handleability to the prints. However, the effects may not be necessarily sufficiently exerted if the charge control agent is used solely. The mechanism of improving handleability of prints using a charge control agent is that a predetermined electrical charge is generated on the front surfaces of prints by the charge control agent, the rear surfaces of the prints are electrically charged with the same sign as the front surfaces, and an electrostatic repulsive force is generated between adjacent prints. However, when image-receiving sheets are conveyed in a printer, electrical charge borne by the rear surfaces thereof vary between positive and negative due to variation in contact area or the like between surfaces of the image-receiving sheets during conveyance. Consequently, the effects of the charge control agent may sometimes be prominent and may sometimes be less prominent.

According to the study of the inventor, it was found that, even if the front and rear surfaces of the prints are electrically charged with the same sign by a charge control agent, with increase of electrical charge due to accumulation of separation electrification generated when unwinding the thermal transfer ribbon, electrical potential difference between the front and rear surfaces may become excessively large and handleability of the prints may be impaired, even though the sign of electrical charge is the same.

The thermal transfer ribbon is electrically charged due to friction generated while being conveyed in the printer. This electrical charging affects handleability of prints. When the transferrable protective layer of a thermal transfer ribbon contains an antistatic agent, electrical charging due to friction during conveyance of the ribbon and electrical charging on the surfaces of prints due to printing operations can both be reduced or prevented. In addition, the excessive electrical charge due to accumulation of separation electrification mentioned above can also be reduced or prevented

Quaternary ammonium salts, which are good antistatic agents, are materials that absorb water and electrically discharge surfaces. Accordingly, these effects can be maximally exerted when a large amount of this material is provided to outermost surfaces. However, since the quaternary ammonium salt combined with water increases friction, if a large amount of this material is contained in the transferrable protective layer, friction between adjacently ejected prints may increase and may reduce the effect of improving handleability.

To prevent this phenomenon, the inventor considered forming the transferrable protective layer into a two-layer structure including first and second layer parts, and having an antistatic agent contained only in the second layer parts which are located farther from the surface of the transferrable protective layer in the print to thereby minimize the influence of friction increased due to the moisture-absorbed antistatic agent. However, according to the study of the inventor, it was found that, although handleability of prints was prevented from being impaired, uneven distribution of the antistatic agent in the second layer parts increased such problems as generation of printing wrinkles and jamming due to the transferrable protective layer being unevenly transferred in the print. This was considered to be because friction on the surfaces of the second layer parts increased in the thermal transfer ribbon, and consequently more friction was caused between the surface of an image-receiving sheet and the transferrable protective layer during transfer of the transferrable protective layer.

Based on the above newly obtained finding, the inventor solved the issues by adding a lubricant to the second layer parts. The thermal transfer ribbon of the present embodiment contains an antistatic agent and a lubricant in the second layer parts 32. In the thermal transfer ribbon 1 before transfer of the transferrable protective layer 30 to an image-receiving sheet, the second layer parts 32 correspond to the upper surface of the transferrable protective layer 30. Therefore, the antistatic agent sufficiently minimizes electrical charge borne by the thermal transfer ribbon due to friction during conveyance thereof, and also favorably prevents possible excessive electrical charge induced by the charge control agent contained in the first layer parts 31. Furthermore, the lubricant reduces friction during transfer of the transferrable protective layer to an image-receiving sheet, and thus reduces printing wrinkles, jamming and the like. In the print after transfer, the first layer parts 31 correspond to the upper surface of the transferrable protective layer. Therefore, the surface of the transferrable protective layer in the print is less likely to be affected by the friction increased by the moisture-absorbed antistatic agent, and favorably exerts the effect of improving handleability of prints.

As described above, the thermal transfer ribbon 1 of the present embodiment can secure good handleability of prints, while minimizing printing wrinkles and the like.

The thermal transfer ribbon of the present invention will be further explained using examples and comparative examples. The present invention is not limited by the contents of the examples and the comparative examples.

The term “part(s)” in the description refers to “part(s) by mass” unless particularly mentioned otherwise.

First, several inks comprising the compositions shown below were prepared.

Each layer forming ink was prepared by measuring and mixing materials first other than methyl ethyl ketone and toluene, and then adding methyl ethyl ketone and toluene, followed by propeller stirring while being heated at 50° C., and then dissolving other materials in the solvent.

<Heat Resistant Lubricating Layer Forming Ink>

| | | |
|---|---|---|
| Polyvinyl acetal resin | 25.2 | parts |
| Isocyanate curing agent | 1.1 | parts |
| Talc | 1.0 | part |
| Methyl ethyl ketone | 36.4 | parts |
| Toluene | 36.3 | parts |

<Yellow Dye Layer Forming Ink>

| | | |
|---|---|---|
| C.I. Solvent Yellow 93 | 7.5 | parts |
| C.I. Solvent Yellow 16 | 2.5 | parts |
| Polyvinyl acetal resin | 8.5 | parts |
| Silicone-modified resin | 0.2 | parts |
| 2,6-tolylene diisocyanate | 1.5 | parts |
| Methyl ethyl ketone | 53.2 | parts |
| Toluene | 26.6 | parts |

<Magenta Dye Layer Forming Ink>

| | | |
|---|---|---|
| C.I. Disperse Red 60 | 5.0 | parts |
| C.I. Disperse Violet 26 | 5.0 | parts |
| Polyvinyl acetal resin | 8.5 | parts |
| Silicone-modified resin | 0.2 | parts |
| 2,6-tolylene diisocyanate | 1.5 | parts |
| Methyl ethyl ketone | 53.2 | parts |
| Toluene | 26.6 | parts |

<Cyan Dye Layer Forming Ink>

| | | |
|---|---|---|
| C.I. Solvent Blue 63 | 5.0 | parts |
| C.I. Solvent Blue 36 | 5.0 | parts |
| Polyvinyl acetal resin | 8.5 | parts |
| Silicone-modified resin | 0.2 | parts |
| 2,6-tolylene diisocyanate | 1.5 | parts |
| Methyl ethyl ketone | 53.2 | parts |
| Toluene | 26.6 | parts |

<First Layer Forming Ink A>

| | | |
|---|---|---|
| Acrylic polyol, Grade name BR-85, manufactured | 10.0 | parts |
| by Mitsubishi Chemical | | |
| Polymer type charge control agent FCA-1001- | 0.1 | parts |
| NS (manufactured by Fujikura Kasei Col, Ltd.) | | |
| Byron 220 | 0.1 | parts |
| Methyl ethyl ketone | 44.8 | parts |
| Toluene | 45.0 | parts |

<First Layer Forming Ink B>

| | | |
|---|---|---|
| Acrylic polyol, Grade name BR-85, manufactured | 10.0 | parts |
| by Mitsubishi Chemical | | |
| Antistatic agent CATIOGEN ES-L9, Quaternary | 0.5 | parts |
| ammonium salt, manufactured by DKS | | |
| (Dai-ichi Seikyaku Kogyo) | | |
| Byron 220 | 0.1 | parts |
| Methyl ethyl ketone | 44.4 | parts |
| Toluene | 45.0 | parts |

<First Layer Forming Ink C>

| | | |
|---|---|---|
| Acrylic polyol, Grade name BR-85, manufactured | 10.0 | parts |
| by Mitsubishi Chemical | | |
| Byron 220 | 0.1 | parts |
| Methyl ethyl ketone | 44.9 | parts |
| Toluene | 45.0 | parts |

<Second Layer Forming Ink 1>

| | | |
|---|---|---|
| Acrylic polyol, Grade name BR-113, manufactured | 10.0 | parts |
| by Mitsubishi Chemical | | |
| Antistatic agent CATIOGEN ES-L9, Quaternary | 0.2 | parts |
| ammonium salt, manufactured by DKS | | |
| (Dai-ichi Seikyaku Kogyo) | | |
| Lubricant EFKA SL3031 | 0.2 | parts |
| 2-(Hydroxy-5-t-butylphenyl)-2H-benzotriazole | 0.5 | parts |
| Methyl ethyl ketone | 89.1 | parts |

<Second Layer Forming Ink 2>

| | | |
|---|---|---|
| Acrylic polyol, Grade name BR-BR-113, manufactured | 10.0 | parts |
| by Mitsubishi Chemical | | |
| Antistatic agent CATIOGEN ES-L9, Quaternary | 0.2 | parts |
| ammonium salt, manufactured by DKS | | |
| (Dai-ichi Seikyaku Kogyo) | | |
| Lubricant KF393 manufactured by Shin-Etsu Chemical Co., | 0.2 | parts |
| Ltd. | | |
| 2-(Hydroxy-5-t-butylphenyl)-2H-benzotriazole | 0.5 | parts |
| Methyl ethyl ketone | 89.1 | parts |

<Second Layer Forming Ink 3>

| | | |
|---|---|---|
| Acrylic polyol, Grade name BR-113, manufactured | 10.0 | parts |
| by Mitsubishi Chemical | | |
| Antistatic agent CATIOGEN ES-L9, Quaternary | 0.2 | parts |
| ammonium salt, manufactured by DKS | | |
| (Dai-ichi Seikyaku Kogyo) | | |
| Lubricant KF-96 (modified dimethyl silicone oil | 0.2 | parts |
| manufactured by Shin-Etsu Chemical Co., Ltd.) | | |
| 2-(Hydroxy-5-t-butylphenyl)-2H-benzotriazole | 0.5 | parts |
| Methyl ethyl ketone | 89.1 | parts |

<Second Layer Forming Ink 4>

| | | |
|---|---|---|
| Acrylic polyol, Grade name BR-113, manufactured | 10.0 | parts |
| by Mitsubishi Chemical | | |
| Antistatic agent CATIOGEN ES-L9, Quaternary | 0.2 | parts |
| ammonium salt, manufactured by DKS | | |
| (Dai-ichi Seikyaku Kogyo) | | |
| Lubricant X-22-2046 (side chain type/cycloaliphatic | 0.2 | parts |
| epoxy-modified silicone oil manufactured by Shin-Etsu | | |
| Chemical Co., Ltd.) | | |
| 2-(Hydroxy-5-t-butylphenyl)-2H-benzotriazole | 0.5 | parts |
| Methyl ethyl ketone | 89.1 | parts |

<Second Layer Forming Ink 5>

| | | |
|---|---|---|
| Acrylic polyol, Grade name BR-113, manufactured | 10.0 | parts |
| by Mitsubishi Chemical | | |
| 2-(Hydroxy-5-t-butylphenyl)-2H-benzotriazole | 0.5 | parts |
| Methyl ethyl ketone | 89.5 | parts |

<Second Layer Forming Ink 6>

| | | |
|---|---|---|
| Acrylic polyol, Grade name BR-113, manufactured | 10.0 | parts |
| by Mitsubishi Chemical | | |
| Lubricant EFKA SL3031 | 0.2 | parts |
| 2-(Hydroxy-5-t-butylphenyl)-2H-benzotriazole | 0.5 | parts |
| Methyl ethyl ketone | 89.3 | parts |

<Second Layer Forming Ink 7>

| | | |
|---|---|---|
| Acrylic polyol, Grade name BR-113, manufactured | 10.0 | parts |
| by Mitsubishi Chemical | | |
| Antistatic agent CATIOGEN ES-L9, Quaternary | 0.2 | parts |
| ammonium salt, manufactured by DKS | | |
| (Dai-ichi Seikyaku Kogyo) | | |
| 2-(Hydroxy-5-t-butylphenyl)-2H-benzotriazole | 0.5 | parts |
| Methyl ethyl ketone | 89.3 | parts |

<Second Layer Forming Ink 8>

| | | |
|---|---|---|
| Acrylic polyol, Grade name BR-113, manufactured | 10.0 | parts |
| by Mitsubishi Chemical | | |
| Polymer type charge control agent FCA-1001-NS | 0.2 | parts |
| 2-(Hydroxy-5-t-butylphenyl)-2H-benzotriazole | 0.5 | parts |
| Methyl ethyl ketone | 89.3 | parts |

<Ink Receptive Layer Forming Ink>

| | | |
|---|---|---|
| Vinyl chloride-vinyl acetate-vinyl alcohol copolymer | 19.5 | parts |
| Amino-modified silicone oil | 0.5 | parts |
| Methyl ethyl ketone | 40.0 | parts |
| Toluene | 40.0 | parts |

A substrate having a heat resistant lubricating layer common to the thermal transfer ribbons of the examples and the comparative examples was prepared through the following procedure.

<Preparation of Substrate Having Heat Resistant Lubricating Layer>

The heat resistant lubricating layer forming ink mentioned above was applied to one surface of a base material (polyethylene terephthalate film with a thickness of 4.5 μm) by gravure coating, followed by drying, to form a heat resistant lubricating layer having a dry thickness of 0.9 μm. After that, the resultant object was aged for 6 days at 50° C., thereby forming a substrate having a heat resistant lubricating layer.

An image-receiving sheet for evaluating the examples and comparative examples was prepared through the following procedure.

<Preparation of Image-Receiving Sheet>

The ink receptive layer forming ink mentioned above was applied to one surface of a base material sheet (foamed polyester film having a thickness of 42 μm) by gravure coating, followed by drying, to form an ink receptive layer having a dry thickness of 5.0 μm. Each image-receiving sheet was obtained in this way.

### EXAMPLE 1

In the substrate having a heat resistant lubricating layer mentioned above, the surface, which was not provided with the heat resistant lubricating layer, was corona-treated. Next, using the yellow dye layer forming ink, the magenta dye layer forming ink, the cyan dye layer forming ink, and the first layer forming ink A mentioned above, yellow dye layer parts, magenta dye layer parts, cyan dye layer parts, and first layer parts were sequentially formed on the substrate by gravure coating. The dye layer parts had a dry thickness of 0.7 μm, and the first layer parts had a dry thickness of 0.5 μm.

Finally, using the second layer forming ink 1, second layer parts were formed on the respective first layer parts by gravure coating. The second layer parts had a dry thickness of 0.5 μm.

In this manner, a thermal transfer ribbon of Example 1 was prepared.

### EXAMPLE 2

A thermal transfer ribbon of Example 2 was prepared as in Example 1, except that the second layer forming ink 2 was used instead of the second layer forming ink 1.

### EXAMPLE 3

A thermal transfer ribbon of Example 3 was prepared as in Example 1, except that the second layer forming ink 3 was used instead of the second layer forming ink 1.

### EXAMPLE 4

A thermal transfer ribbon of Example 4 was prepared as in Example 1, except that the second layer forming ink 4 was used instead of the second layer forming ink 1.

### Comparative Example 1

A thermal transfer ribbon of Comparative Example 1 was prepared as in Example 1, except that the first layer forming ink C was used instead of the first layer forming ink A, and the second layer forming ink 5 was used instead of the second layer forming ink 1.

### Comparative Example 2

A thermal transfer ribbon of Comparative Example 2 was prepared as in Example 1, except that the first layer forming ink C was used instead of the first layer forming ink A, and the second layer forming ink 6 was used instead of the second layer forming ink 1.

### Comparative Example 3

A thermal transfer ribbon of Comparative Example 3 was prepared as in Example 1, except that the first layer forming ink C was used instead of the first layer forming ink A, and the second layer forming ink 7 was used instead of the second layer forming ink 1.

### Comparative Example 4

A thermal transfer ribbon of Comparative Example 4 was prepared as in Example 1, except that the first layer forming ink C was used instead of the first layer forming ink A, and the second layer forming ink 8 was used instead of the second layer forming ink 1.

### Comparative Example 5

A thermal transfer ribbon of Comparative Example 5 was prepared as in Example 1, except that the second layer forming ink 2 was used instead of the second layer forming ink 1.

### Comparative Example 6

A thermal transfer ribbon of Comparative Example 6 was prepared as in Example 1, except that the first layer forming ink B was used instead of the first layer forming ink A, and the second layer forming ink 6 was used instead of the second layer forming ink 1.

### Comparative Example 7

Using the second layer forming ink 8, a transferrable protective layer having a single-layer structure was formed by gravure coating. The transferrable protective layer had a dry thickness of 1.2 μm. Except for this, a thermal transfer ribbon of Comparative Example 7 was prepared as in Example 1.

### Comparative Example 8

A thermal transfer ribbon of Comparative Example 8 was prepared as in Comparative Example 7, except that the second layer forming ink 7 was used instead of the second layer forming ink 8.

### Comparative Example 9

A thermal transfer ribbon of Comparative Example 9 was prepared as in Example 1, except that the second layer forming ink 7 was used instead of the second layer forming ink 1.

### Comparative Example 10

A thermal transfer ribbon of Comparative Example 10 was prepared as in Example 1, except that the first layer forming ink B was used instead of the first layer forming ink A, and the second layer forming ink 8 was used instead of the second layer forming ink 1.

<Preparation of Evaluation Prints>

The thermal transfer ribbons of the examples and the comparative examples were each loaded on a thermal photo printer D-70 (manufactured by Mitsubishi Electric Corporation), and a predetermined image was printed on the ink receptive layer of the image-receiving sheet, thereby obtaining evaluation prints for the examples and the comparative examples.

Evaluation was conducted as follows based on the evaluation prints for the examples and the comparative examples, and the operation during preparation of the prints.

<Handleability>

As evaluation prints, 20 gray (entire surface) prints were printed and ejected to a dedicated tray. The 20 prints were attempted to be aligned by bundling them together and dropping them from a height of about 2 cm, in a direction perpendicular to the desk. The prints were evaluated on a 3-point scale. Specifically, if the prints were aligned within 5 attempts, they were evaluated as good, if the prints were aligned with 6 or more attempts and 10 or less attempts, they were evaluated as fair, and if the prints were not aligned within 10 attempts, they were evaluated as poor.

<Printing Wrinkles>

Monochrome half-images were printed as evaluation prints. The prints were evaluated on a 2-point scale. Specifically, if wrinkles were not visually observed on the surfaces of the prints, they were evaluated as good, and if wrinkles were visually observed, they were evaluated as poor.

<Electrical Charge Borne by Ribbons>

The thermal transfer ribbons of the examples and the comparative examples were each placed on a dedicated tray to measure the amount of electrical charge borne, using a charge potential measuring device. The ribbons were evaluated on a 3-point scale. Specifically, if the charge potential was in the range of −5 KV or more and +5 KV or less, the ribbons were evaluated as good, if the charge potential was out of the good evaluation range and in the range of −15 KV or more and +15 KV or less, the ribbons were evaluated as fair, and if the charge potential was out of the fair evaluation range and less than −15 KV, or more than +15 KV, the ribbons were evaluated as poor.

The results are shown in Table 1.

TABLE 1

| | | | | | Comp. | Comp. | Comp. | Comp. | Comp. | Comp. |
|---|---|---|---|---|---|---|---|---|---|---|
| | Ex. 1 | Ex. 2 | Ex. 3 | Ex. 4 | Ex. 1 | Ex. 2 | Ex. 3 | Ex. 4 | Ex. 5 | Ex. 6 |
| <Handleability> | Good | Good | Good | Good | Poor | Poor | Poor | Poor | Fair | Good |
| <Printing wrinkles> | Good | Good | Good | Good | Good | Good | Poor | Good | Good | Poor |
| Charge of ribbon | Good | Good | Good | Good | Poor | Poor | Good | Fair | Fair | Good |

As shown in Table 1, all of the examples satisfied both good handleability and minimization of printing wrinkles.

As can be seen from the results of Comparative Example 2, handleability is not improved by use of only a lubricant.

As can be seen from the results of Comparative Examples 3 and 4, handleability is not improved by use of only a charge control agent or only an antistatic agent, irrespective of the position of the agent comprised in the transferrable protective layer.

As can be seen from the results of Comparative Examples 3, 8 and 9, printing wrinkles are not sufficiently minimized when the second layer parts of the transferrable protective layer contain an antistatic agent but do not contain a lubricant.

The thermal transfer ribbon of the present invention can be used for sublimation transfer type printers. Use of the thermal transfer ribbon of the present invention imparts good handleability to prints after thermal transfer of the thermally transferrable protective layer onto a produced image, and causes no observable wrinkles in the prints obtained. Thus, the thermal transfer ribbon disclosed here is expected to be applied to cards, such as ID cards, and various other fields requiring output of various colors.

### INDUSTRIAL APPLICABILITY

The thermal transfer ribbon of the present invention can be used for sublimation transfer type printers.

### REFERENCE SIGNS LIST

1 Thermal transfer ribbon; 10 Substrate; 20 Dye layer; 30 Transferable protective layer; 31 First layer part; 32 Second layer part.

What is claimed is:

1. A thermal transfer ribbon, comprising:
a substrate, the substrate having a surface provided with dye layer parts and transferable protective layer parts repeatedly formed thereon,
wherein the transferrable protective layer parts include first layer parts formed on the substrate, and second layer parts formed on the respective first layer parts;
the first layer parts contain a charge control agent; and
the second layer parts contain an antistatic agent and a lubricant.

2. The thermal transfer ribbon of claim 1, wherein the charge control agent contains at least one of an azine compound, a styrene acrylic polymer, an azo-containing metal compound, and a salicylic acid compound.

3. The thermal transfer ribbon of claim 1, wherein the antistatic agent contains any of a cationic surfactant, an anionic surfactant, a metallic electrically conductive polymer, a metal oxide, and a compound comprising hydroxyl groups.

4. The thermal transfer ribbon of claim 1, wherein a content of the charge control agent in the first layer parts is in a range of 0.1 mass % to 5.0 mass %.

5. The thermal transfer ribbon of claim 1, wherein a content of the antistatic agent in the second layer parts is in a range of 0.1 mass % to 10.0 mass %.

6. The thermal transfer ribbon of claim 1, wherein the lubricant is silicone oil comprising a siloxane-modified product.
